(19) United States
(12) Patent Application Publication
(10) Pub. No.: US 2006/0048187 A1
(43) Pub. Date: Mar. 2, 2006

(54) Method for drawing up a list of contents in a device connected to a domestic network and device associated with said method

(76) Inventors: Willem Lubbers, Cesson Sevigne (FR); Yves Maetz, Nelesse (FR); Ralf Schaefer, Acigne (FR)

Correspondence Address: THOMSON LICENSING INC., PATENT OPERATIONS, PO BOX 5312, PRINCETON, NJ, 08543-5312, US

(21) Appl. No.: 10/540,149

(22) PCT Filed: Dec. 29, 2003
(86) PCT No.: PCT/EP03/51111

§ 371 Date: Jun. 21, 2005

(30) Foreign Application Priority Data
Jan. 2, 2003 (FR) 0300007

(51) Int. Cl. H04N 5/445; G06F 13/00; G06F 3/00

(52) U.S. Cl. 725/46; 725/45; 725/39

(57) ABSTRACT

The invention relates to a method for drawing up a list of contents in a controller device connected to a domestic network, said list enumerating the contents provided by various devices connected to the domestic network. The inventive method consists in transmitting a command specifying a filtering criterion from the controller device; in drawing up a local list in each device upon reception of said command; in transferring each local list to the controller device from the device in which the last was drawn up; and in assembling the local lists in the controller device in order to form a list of contents. The user can thus select a filtering criterion such as sports for example and can view the list of contents which enter into said filtering category and which are available for all devices. Quick content searches can also be carried out by the user. The invention also relates to a device enabling a list of contents to be drawn up according to said message.

The invention relates to a method of creating a list of contents in a controlling device connected to a domestic network to which are connected a number of devices each supplying contents.

The invention applies to the presentation of contents in a digital domestic network in which devices intercommunicate using, for example, the HAVi protocol. The term “content” is understood here to mean an audio-video service such as a broadcast or a film transmitted on a digital television channel, a pre-recorded film, an mp3 audio file stored on a hard disk or a walkman, or even an audio file from an audio optical disk drive. A list of contents corresponds here to a collection of metadata. A metadata item describes the content by attributes; for example, the metadata of a film comprises, among other things, attributes such as its release date, its type, the actors and its summary. The metadata is described, for example, in the document accessible on the site http://xml.coverpages.org/TVAnytime-SP003v11.pdf.

The devices interconnected by the domestic network may be, for example, tuners each receiving a number of digital channels transmitted by satellite or by digital terrestrial means, data storage means such as hard disks in which are stored contents, DVD players, and television terminals. In a domestic network, the number of audio-video and audio services potentially available can be high. As an indication, there are currently around a thousand channels transmitted by satellite free of charge, that is, accessible with no particular subscription, from a decoder.

In such an installation, the user can control the domestic network from one of the devices which becomes a controlling device, via an application that uses a communication protocol such as, for example, the HAVi protocol. This device is, for example, a television capable of displaying an application interface enabling the user to make selections in menus using a remote control. The user can thus ascertain the various devices connected and a certain number of properties and characteristics of the latter. He can also, for each given device, look up the list of contents available on that device. When the user wants to view a particular content, he must then control the application for looking up on each device in turn each list of contents until he sees the content he wants to view. This operation is relatively lengthy because, for each look-up operation, the controlling device needs to communicate with the corresponding device to recover information and display the corresponding list of contents. Consequently, choosing a particular content is relatively lengthy and tedious, to the extent that this option is not practical for use by the user.

U.S. Pat. No. 6,140,334—ALLPORT describes a remote control controlling a number of devices using an infra-red link. The remote control communicates with the devices to send commands and, where appropriate, receive information. Since the devices are fixed, they cannot intercommunicate by infra-red, so they do not constitute a domestic network. The remote control has to interrogate each device individually to obtain all the information.

Document WO 00/40017—HANCOCK describes a system comprising a television connected to a receiver of signals from a cable, a decoder receiving signals from a satellite antenna, a video recorder or other input devices. The devices are linked by dedicated links and are not connected using a domestic network. In practice, to store transmissions on the video recorder from the cable or the satellite, this cannot be done by the TV, a dedicated link is needed as shown in FIG. 1. This document presents another solution to the problem of overloading the network involving eliminating the network and setting up dedicated links between two devices.

The object of the invention is to overcome these problems by proposing a method for creating such a list more quickly.

To this end, the object of the invention is to devise a method for creating a list of contents in a controlling device connected to a domestic network to which are connected a number of devices, each supplying contents, characterized in that it consists in sending, from the controlling device, a command specifying a filtering criterion, in creating in each device a local list on receipt of this command, each local list itemizing the contents supplied by the device in which it is created and involved in the filtering criterion specified by the command, in transferring each local list from the device in which it is created to the controlling device, and in assembling in the controlling device the local lists received to form the list of contents.

The user can thus select a filtering criterion such as, for example, “sports”, and view the list of contents involved in this filtering criterion and available on all the devices. The search for a particular content on the entire network is thus completed in a very short time. The response time is optimized by the fact that the quantity of data circulating in the network is reduced to the data relating to a filtering criterion. This response time is also optimized by the fact that the filtering processes needed to create a list of contents corresponding to a filtering criterion are performed simultaneously in the various devices connected to the network instead of being centralized in a single device.

In a preferred embodiment, after the creation of a local list in a device, a notification is sent from that device to the controlling device, and each local list is transferred on receipt of a transfer request sent by the controlling device. The quantity of data circulating in the domestic network is thus managed by the controlling device independently of the load that is applied to the devices connected to the network to create the local lists.

In another embodiment, the controlling device sends transfer requests to a connected device, not systematically, but following a request from the user. An additional condition is needed to send the transfer requests, in particular a specific action on the part of the user. Thus, the time needed to create the local lists in the devices connected to the network can be masked. In this embodiment, the devices connected to the network are ordered by the controlling device to create local lists each time a filtering criterion is selected by the user in the application running on the controlling device. When the user confirms his choice, the transferring of the local lists is initiated to create the list of contents in the controlling device.

In another embodiment, each transfer request is sent from the controlling device on receipt of the corresponding notification. Advantageously, the application can be designed to assemble the local lists dynamically as they are received in the controlling device. In this way, the responsiveness of the system is enhanced by avoiding having to wait for all the local lists to have been formed before starting to display the list of contents in the controlling device.

The invention also proposes a device connected to a domestic network, and designed to supply contents. This device comprises programmed means for creating a local list on receipt of a command received from the network specifying a filtering criterion, this local list itemizing the contents supplied in the device and involved in the filtering criterion specified by the command. This device also comprises means for transferring via the network this local list to another device connected to the network.

The invention also proposes a device connected to a domestic network, and designed to display a list of contents. This device comprises programmed means for sending over the network a command specifying a filtering criterion, and for transferring via the network a local list from another device connected to the network, this local list having been created in response to the command.

The invention also proposes a device connected to a domestic network, designed to supply contents and display a list of contents. This device comprises programmed means for creating a local list on receipt of a command specifying a filtering criterion, this local list itemizing the contents supplied in the device and involved in the filtering criterion specified by the command, and for transferring via the network this local list to another device connected to the network. This device also comprises programmed means for sending over the network a command specifying a filtering criterion, and for transferring via the network a local list from another device connected to the network.

The invention will now be described in greater detail, and with reference to the appended drawings which illustrate an embodiment of the latter by way of no limiting example.

FIG. 1 is a diagrammatic representation of a domestic network;

FIG. 2 is a representation of the method according to the invention in the form of a dynamic interchange diagram;

FIG. 3 is a representation of the method according to the invention in the form of a sequential diagram;

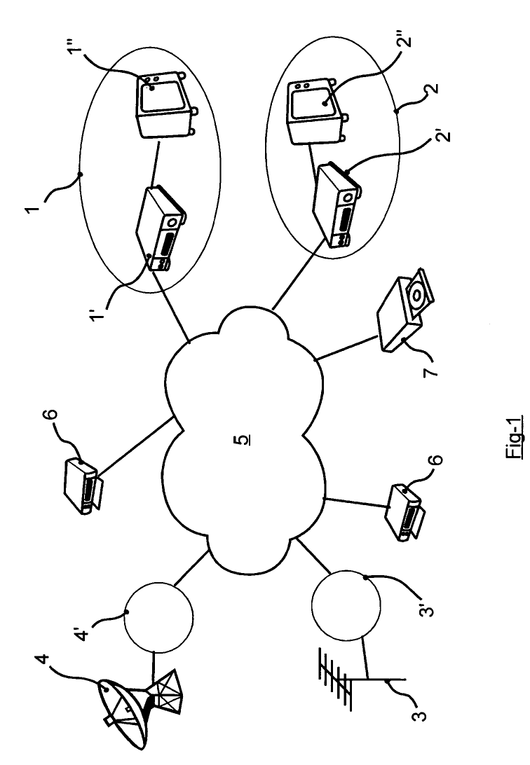

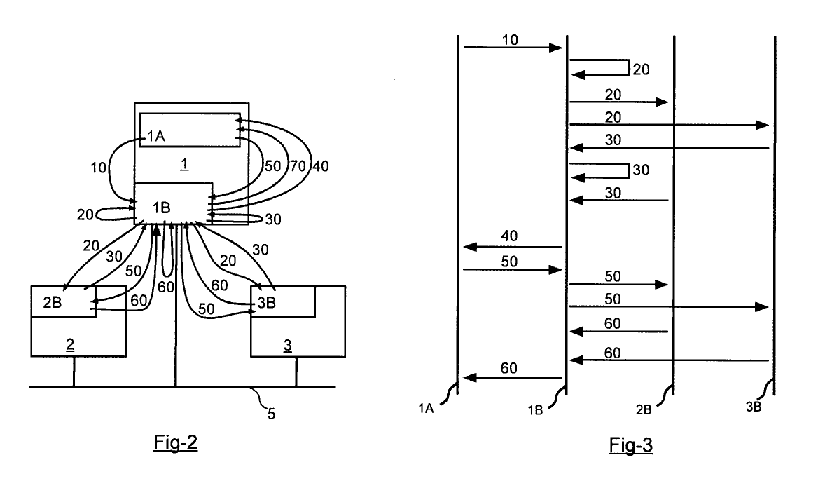

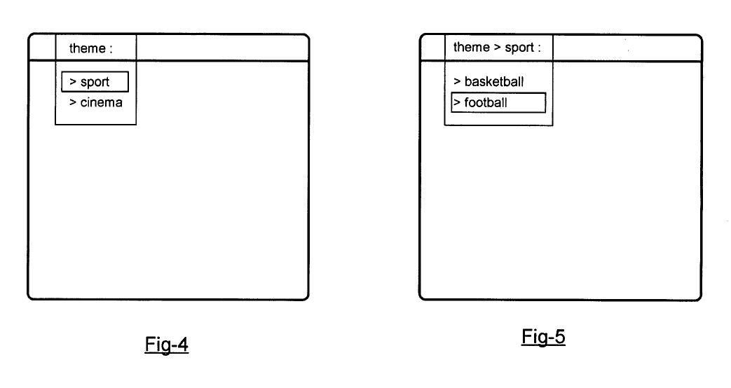

FIG. 4 is a first example of selection of a filtering criterion with the method according to the invention;

FIG. 5 is a second example of selection of a filtering criterion with the method according to the invention.

FIG. 1 shows an example of domestic network comprising two sets of television channel receivers 1 and 2, each set including a decoder 1′, 2′ connected to a television 1″, 2″. The set comprising a television and a decoder can be formed by two separate elements linked to each other and sold separately, but the decoder can also be integrated in a digital television. Each decoder 1′ is connected to other devices by a domestic network 5. These devices include an antenna 3 linked to the network 5 via a tuner 3′ to receive digital channels transmitted by digital terrestrial means. Similarly, a dish antenna 4 is linked to the network 5 via another tuner 4′, to receive digital channels transmitted by satellite. Each set 1, 2 that are linked to the network 5 are thus designed to access both the digital terrestrial channels received on the antenna 3 and the channels transmitted by satellite. The installation also includes two hard disks 6 in which can be stored films or other contents such as MP3 files and a CD or DVD player 7, connected to the network 5 such that each set 1, 2 can access their content. Each device connected to the network 5 also comprises a central processing unit associated with memory means and communication means. Said memory means contain an executable program.

The set 1 is in this case designed to run an application, the interface of which is displayed on the television 1″ and which can be driven by the user using a remote control to navigate in the menus in order to view contents supplied by the other devices connected to the network 5. This application also comprises functionalities for viewing lists of contents supplied by these devices.

According to the invention, the creation of a list of contents in the controlling device 1 consists in sending from this controlling device 1 a command specifying a content filtering criterion to create local lists in the different devices connected to the network 5. Advantageously, this command is transmitted throughout the network without specifying recipient devices, each device of the network deciding whether to respond to it. This transmission saves on bandwidth and avoids having to send as many commands as there are devices. The devices that have no content corresponding to the criterion do not need to respond, which avoids sending an empty list. Each local list that is created in a device connected to the network 5 on receipt of the command itemizes the contents involved in the filtering criterion specified by the command, to form local lists of smaller sizes. The local lists are then transferred to the controlling device where they can be assembled to form the requested list.

With this method, the processes needed to create the lists are carried out in parallel and are performed simultaneously in a number of devices connected to the network, so providing a significant time saving. Also, the quantity of data circulating in the network is relatively small since only the data corresponding to the filtering criterion specified by the user (defined by a local list) is transmitted to the controlling device. More particularly, the application is designed so that the user can select from it a filtering criterion, in order to ask for a list of contents involved in this filtering criterion to be displayed. This filtering criterion may be, for example, “sport”, such that the corresponding list of contents itemizes broadcasts or reports of a sporting nature. The search for a content is thus simplified by the fact that it is directly conditioned to a filtering criterion, which means that the quantity of data circulating in the network is reduced while enabling a list of contents available on different devices connected to the network to be created in a very short time. The commands are sent from a controlling device such as, for example, device 1 or device 2, to the other devices connected to the network 5. However, each device connected to the network can be a controlling device, such that all these devices form a multi-controller system in which a number of devices can be both controlling and controlled.

This method also improves the robustness of the system since the data is stored in different devices, so that a failure of one of the devices does not mean that all the data is lost.

The method according to the invention is represented diagrammatically in FIGS. 2 and 3, in which three devices 1, 2 and 3 are interconnected via a domestic network 5. The device 1 in this case serves as a controlling device to create a list of contents.

In a preferred embodiment of the invention, the creation of a local list by a device 2, 3 is followed by the transmission to the controlling device 1 of a notification 30, and the transfer of a local list 60 to the controlling device 1 is performed on receipt by the corresponding device of a transfer request 50 sent by the controlling device 1. The controlling device 1 is thus able to manage independently the quantity of data circulating in the network 5 and the processing load that it requests of each device 2, 3.

This characteristic involving sending a notification 30 when a local list is created and transmitting this local list 60 on receipt of a transfer request 50 is particularly advantageous for optimizing the response times of the system by enabling its operating mode to be modulated. In an embodiment, the controlling device 1 orders at 20 the connected devices 2, 3 to create local lists, and transfer requests 50 are sent following a specific action performed by the user.

The processing time in the devices 2, 3 connected to the domestic network 5 can thus be masked. More particularly, a command 20 is sent each time a filtering criterion is selected by the user in the application running on the controlling device 1. In the example of FIG. 4, the user selects the “sport” topic from “sport” and “cinema”, which generates a first command 20 following which local lists corresponding to the “sport” filtering criterion are created in the devices connected to the network 5. In a next step represented in FIG. 5, the user selects “football” from the “sport”, “football” and “basket-ball” topics, which generates a second command 20 inducing the creation of local lists corresponding to “football” in the connected devices. The data that will be required to create the list of contents corresponding to “football” in the controlling device 1 is thus ready in the devices 2, 3 connected to the network. When the user confirms the “football” selection by a specific confirmation action on his remote control, the transfer requests 50 are sent to initiate the local list transfers at 60 to the controlling device 1. This means that the required list of contents can be formed, that is, in the example of FIGS. 4 and 5, the list of football matches currently available.

This embodiment is particularly well suited to the case where the user chooses his filtering criterion by successive selections in the application interface. At any time, the selection in which the user is located can be the filtering criterion for which he wants to view the list of contents, and the corresponding data is computed constantly in the different devices connected to the network. When the user confirms the selection in which he is located, the data is ready and all that remains is for the data to be transferred to the controlling device, so providing a significant time saving.

Advantageously, the dynamic contents such as, for example, the audio-visual programs received by satellite or digital terrestrial means transmitted constantly, can be stored and updated locally so as to be available more quickly when a user requests them. In this case, a controlling device sends commands 20 cyclically to the devices 3 and 4 which receive the dynamic programs so that the latter form local lists and maintain up-to-date local lists. When the user wants to look up the content lists of these devices, transfer requests 50 are sent to initiate the transfer of the up-to-date local lists to the corresponding controlling device. In this way, the management of dynamic content lists consists in keeping these local lists up-to-date without generating a significant load on the network since the data is transferred only when the controlling device asks for it.

In another embodiment, the controlling device sends each transfer request 50 on receipt of a notification 30. Advantageously, the application can be designed to assemble the local lists dynamically as they are received at 60 in the controlling device. In this way, the responsiveness of the system is improved by avoiding having to wait for all the local lists to have been assembled before starting to display partially the list of contents in the controlling device.

The invention can advantageously be produced in the form of a component of a communication protocol implemented in programmable means integrated in each device, so as to form an additional functionality of the protocol that can be driven by an application. Such a component, also called system component, can, for example, be incorporated in the HAVi protocol which is provided to receive such components forming, as it were, extensions to the basic functions offered by the HAVi protocol. In this way, it is possible to incorporate the advantages provided by the HAVi protocol, in particular regarding the recognition, in real time and transparently for the user, of the connection or disconnection of a device on the network 5. In practice, the HAVi protocol includes this functionality, so that the connection or disconnection of a device is immediately signalled to the other devices, which means that a list of contents in a device can be updated quickly by subsequently triggering the corresponding requests. Referring again to FIG. 2, it can be seen that the requests represented by the arrows 10 to 70 which circulate between the devices 1, 2 and 3 via the network 5, are in fact managed by the protocol operating the domestic network in which the blocks 1B, 2B, 3B are incorporated. More particularly, on receipt of a command such as 20, the corresponding component creates the local list of contents available in the device in which it is incorporated and corresponding to the filtering criterion contained in the command 20. Advantageously, this component is driven by the application 1A to manage the different events leading to the formation of a list of contents. This application 1A is a software application which can, for example, be downloaded into the memory of a device, from a medium, in such a way that it is possible to have the latest update without having to change device.

In the example of FIG. 2, the application 1A sends at 10 a content list request to the component 1B. The component 1B converts this content list request into a number of commands 20 which are sent over the network respectively to the devices 2, 3 and to the component 1B itself. Each component 1B, 2B and 3B then creates a local list before sending the corresponding notifications 30 towards the component 1B. The application 1A is then informed at 40 when all the notifications 30 have been received at 1B. The transfers of the different local lists are ordered by the application 1A which drives the component 1B at 50 so that it uploads the local lists from the devices 2 and 3. This leads to the transfer requests illustrated by the arrows 50, and to the subsequent transfers 60. The local lists are then assembled in the component 1B and transmitted to the application 1A at 70 for display to the user.

The exemplary embodiments of the invention described above were chosen for their concrete nature. However, it would not be possible to provide an exhaustive list of all the embodiments covered by this invention. In particular, any step or any means described can be replaced by an equivalent step or means without departing from the framework of the present invention.

1. Method for creating a list of contents in a controlling device connected to a domestic network to which are connected a number of devices, each supplying contents, wherein it comprises:
sending over the network, from the controlling device, a command specifying a filtering criterion,
creating in each device a local list on receipt of this command, each local list itemizing the contents supplied by the device in which it is created and involved in the filtering criterion specified by the command,
transferring via the network each local list from the device in which it is created to the controlling device, and
assembling in the controlling device the local lists received from the network to form the list of contents.

2. Method according to claim 1, wherein, after the creation of a local list in a device, a notification is sent from that device to the controlling device, and in which each local list is transferred on receipt of a transfer request sent by the controlling device.

3. Method according to claim 2, wherein the controlling device sends transfer requests to each connected device following a specific action on the part of the user.

4. Method according to claim 2, wherein each transfer request is sent from the controlling device on receipt of the corresponding notification.

5. Method according to claim 4, consisting in creating the list of contents in the controlling device by assembling the local lists dynamically as they are received.

6. Method according to claim 1, consisting in sending a single command to all the network without specifying recipient devices, each device receiving the command deciding whether to respond to it.

7. Device connected to a domestic network, and designed to supply contents, wherein it comprises programmed means for creating a local list on receipt of a command specifying a filtering criterion, this local list itemizing the contents supplied in the device and involved in the filtering criterion specified by the command, and for transferring via the network this local list to another device connected to the network.

8. Device connected to a domestic network, and designed to display a list of contents, wherein it comprises programmed means for sending over the network a command specifying a filtering criterion, and for transferring via the network a local list from another device connected to the network, this local list having been created in response to the command.

9. Device connected to a domestic network, designed to supply contents and display a list of contents, wherein it comprises programmed means for creating a local list on receipt of a command specifying a filtering criterion, this local list itemizing the contents supplied in the device and involved in the filtering criterion specified by the command, and for transferring via the network this local list to another device connected to the network, and programmed means for sending over the network a command specifying a filtering criterion, and for transferring via the network a local list from another device connected to the network.
